(19) United States
(12) Patent Application Publication
(10) Pub. No.: US 2015/0278954 A1
(43) Pub. Date: Oct. 1, 2015

(54) DETERMINING AN INVESTMENT OBJECTIVE OF ASSETS

(71) Applicant: BANK OF AMERICA CORPORATION, CHARLOTTE, NC (US)

(72) Inventors: Anil Suri, Jersey City, NJ (US); Sujeet Banerjee, Bayonne, NJ (US)

(73) Assignee: BANK OF AMERICA CORPORATION, Charlotte, NC (US)

(21) Appl. No.: 14/226,556

(22) Filed: Mar. 26, 2014

(51) Int. Cl. G06Q 40/06

(52) U.S. Cl. CPC G06Q 40/06

(57) ABSTRACT

Systems, methods and apparatuses for determining and aligning a calculated investment objective with a client-designated investment objective using a beta-yield method are described. A growth factor and a yield of a portfolio of securities assets may be calculated and compared to growth factor ranges and yield ranges associated with different investment objective strategies. The different growth factor ranges may be defined based on at least two thresholds, and the yield ranges may be defined based on a bond index yield and a stock index yield. By determining which growth ranges and yield ranges cover the calculated growth factor and yield, a calculated investment objective of the portfolio of assets can be determined. The calculated investment objective can be compared to the client-designated investment objective for the portfolio to determine whether the portfolio holdings are in alignment with the client-designated investment objective.

### BACKGROUND

In wealth management products, clients or customers may have investment accounts with certain investment objectives in mind for these accounts. The investment objectives may depend on the customer's financial needs and risk appetite. Since investment objectives can depend on the various holdings and allocations between types of holdings and market conditions, alignment with an investment objective may be difficult to evaluate. It is desirable to use a quantitative determination of whether an allocation of assets or asset holdings are in alignment or consistent with the customer's investment objectives.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems and apparatuses for determining and aligning a calculated investment objective with a client-designated investment objective using a beta-yield method. In some aspects, a growth factor and a yield of a portfolio of securities assets may be calculated and compared to growth factor ranges and yield ranges associated with different investment objective strategies. The different growth factor ranges may be defined based on at least two thresholds, and the yield ranges may be defined based on a bond index yield and a stock index yield. By determining which growth ranges and yield ranges cover the calculated growth factor and yield, a calculated investment objective of the portfolio of assets can be determined. The calculated investment objective can be compared to the client-designated investment objective for the portfolio.

In some aspects, a user interface or tool may be provided to enable a user to adjust holdings in an account or portfolio to change or align the calculated investment objective with the client-designated investment objective. The user interface or tool may be a scenario analysis tool which enables calculation of hypothetical holdings scenarios to obtain a hypothetical calculated investment objective for the holdings scenarios.

In some aspects, the investment objective of a set of holdings may be recalculated and a notification or alert mechanism may be provided which alerts a user to misalignment between a recalculated investment objective and a client-designated investment objective.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates example investment objective strategies according to one or more aspects described herein.

FIG. 4 is an example method according to one or more aspects described herein.

FIG. 5 illustrates an example user interface according to one or more aspects described herein.

FIG. 6 illustrates an example computing system according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced.

It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

As will be discussed further below, aspects described herein relate to analyzing a portfolio of investment holdings to determine whether the current holdings meet or align with investment objectives for the portfolio using a beta-yield methodology. The beta and yield of the investments in a portfolio may be calculated to determine a calculated investment objective such as an income strategy, a growth strategy, or a total return strategy which may be defined as specific ranges of income return and risk or volatility. Income return may be represented by a calculated yield and risk or volatility may be represented by a calculated beta. The calculated investment objective may be used to determine whether the current holdings are in alignment with the customer's designated investment objective for the account or portfolio. In some aspects, the beta-yield methodology may be provided in the form of a tool which may be used to add or remove hypothetical holdings to provide an indication of the effect of the addition or removal on a calculated investment objective. The tool may be used to facilitate changes in the holdings to affect the calculated investment objective.

These and additional examples and arrangements will be discussed more fully below.

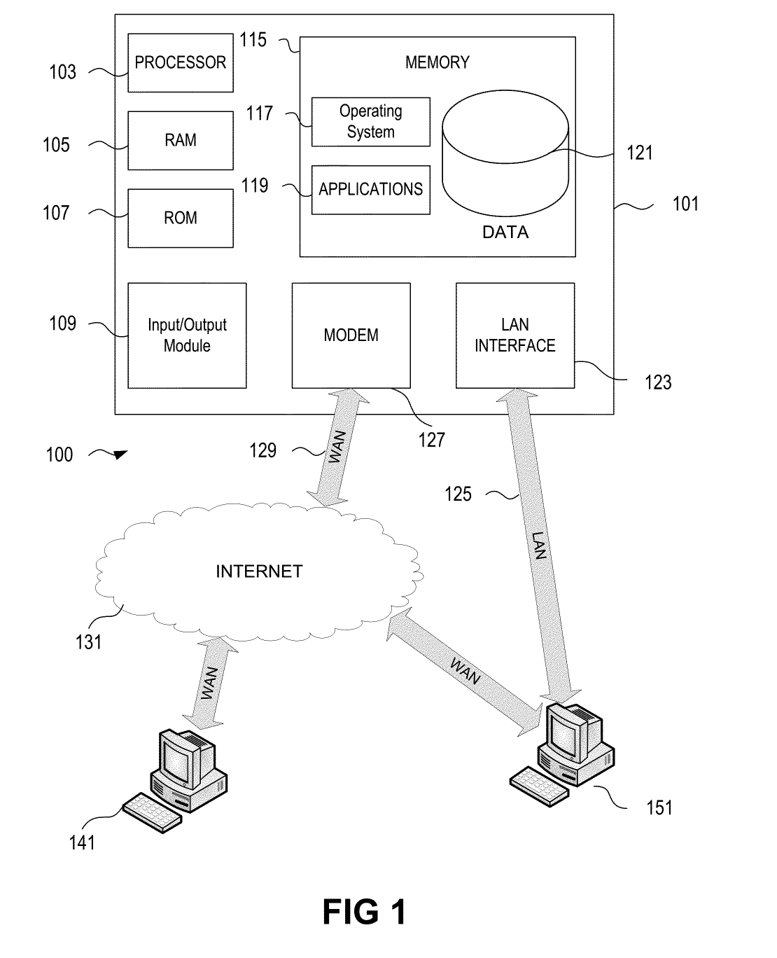

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

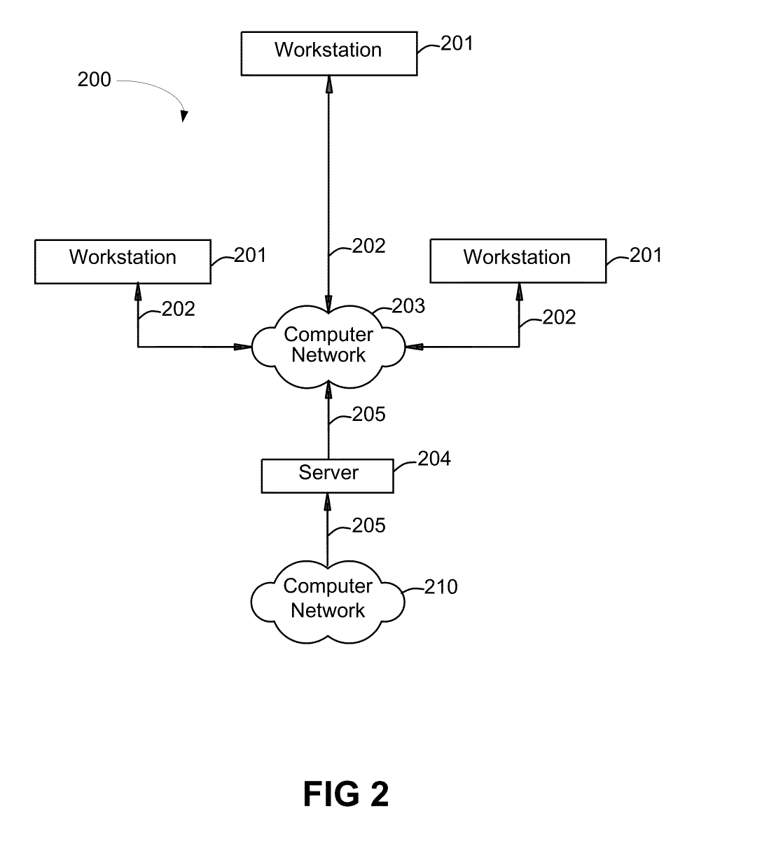

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

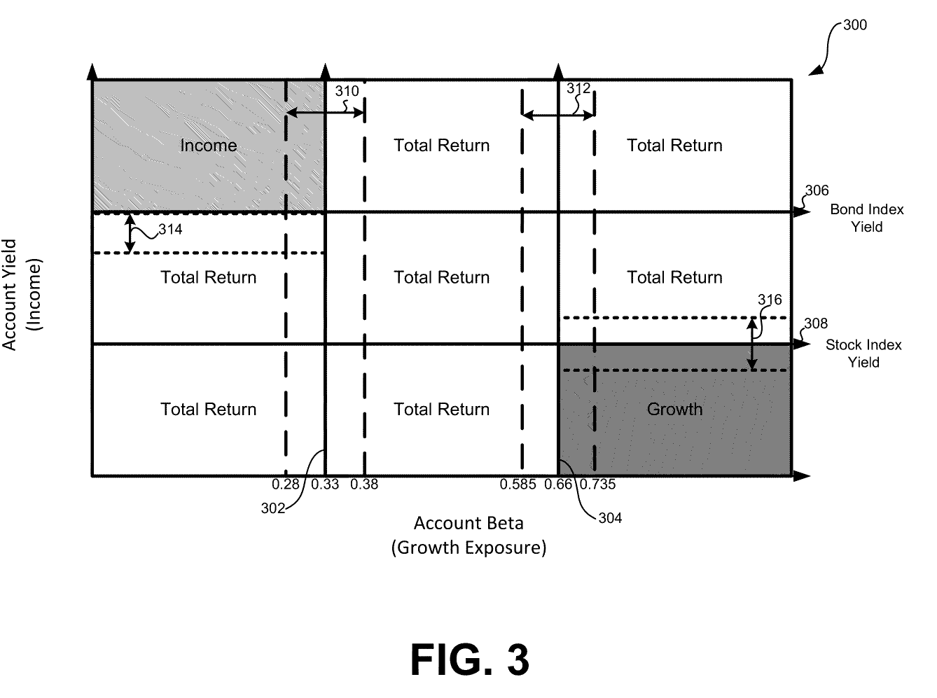

FIG. 3 illustrates an example of investment objective categories based on account beta and account yield of securities 300. FIG. 3 shows an example of three different investment objective categories or strategies including income, growth, and total return. An income strategy may be a portfolio of securities holdings structured to primarily generate income which may be in the form of dividend payments for stock holdings or interest income for bond holdings. A growth strategy may be a portfolio of securities holdings structured to primarily produce growth through price appreciation. A strategy or investment objective which is not categorized as an income strategy or a growth strategy may be considered to be a total return strategy. In other words, a total return strategy may be a portfolio of securities holdings structured to generate a combination or blend of income and growth. A securities holding may be ownership of stock in a company or ownership of a bond issued by an entity (e.g., corporation, government, municipal).

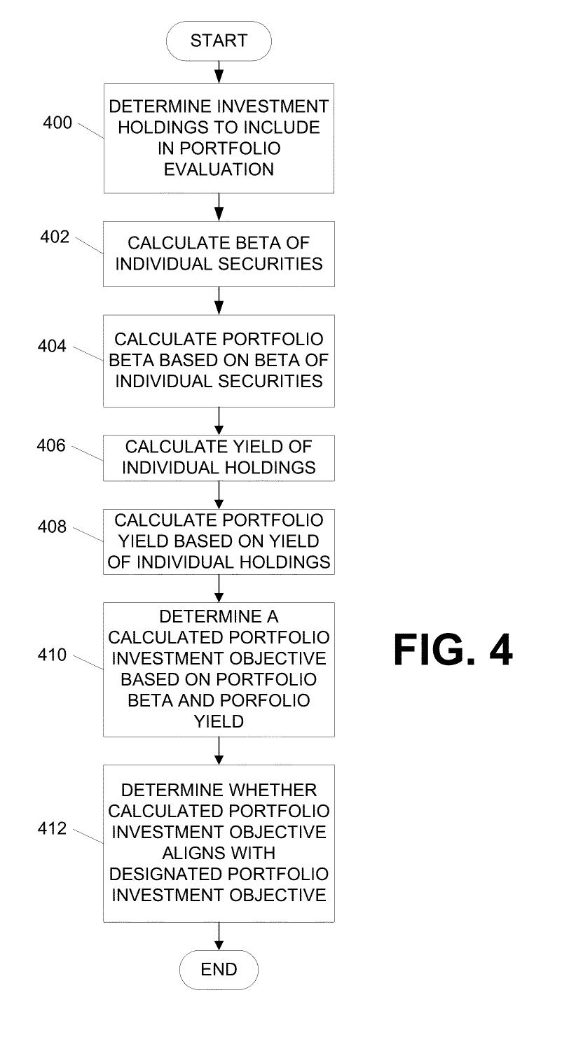

The investment objective strategies of securities holdings may be characterized based on a volatility or risk associated with the securities and income generated by the securities. The volatility or risk may be represented using beta or standard deviation by calculating a beta of the securities or a standard deviation of the securities in the holdings, and the income generated by the securities may be determined by calculating a yield of the securities. Generally, an income type strategy or investment objective may have a high yield and low beta. A growth type strategy or investment objective may have low yield and high beta, and a total return type strategy or investment objective may have an intermediate yield and an intermediate to high beta. The calculation of the beta and the yield will be described in more detail with respect to FIG. 4.

The account beta may be a beta value representing the overall volatility or risk associated with all of the securities holdings in the account. The account beta may be compared to beta values or beta threshold values defining a low beta, intermediate beta, and high beta. For example, a first beta threshold or value 302 and a second beta threshold or value 304 may be used to define the various beta levels. Values below the first beta threshold 302 may be considered to be a low beta, and values between the first beta threshold 302 and the second beta threshold 304 may be an intermediate beta. A beta value greater than the second beta threshold 304 may be a high beta. In the example shown in FIG. 3, the first beta threshold value is 0.33 and the second beta threshold value is 0.66. Different beta threshold values may be used depending on how the investment objectives are defined.

In another aspect, the account beta range between 0 and the first threshold 302 with the account yield range between stock index yield 308 and bond index yield 306 may be categorized as an income investment objective. The account beta range greater than second threshold 304 with the account yield range less than bond index yield 306 may be categorized as a growth investment objective.

The account yield may be a yield value representing the overall yield associated with all of the securities holdings in the account. The account yield may be compared to a bond index yield level or value 306 and a stock index yield level or value 308 to determine whether the account yield corresponds to income, growth, or total return. Based on the calculated account beta and account yield, a calculated investment objective for the account may be determined depending on the range in which the account beta and account yield fall. As illustrated in FIG. 3, a calculated investment objective for a given account may be determined from a calculated account beta and account yield. For example, if the account beta is between 0 and 0.33 (e.g., first beta threshold 302) and the account yield is greater than bond index yield 306, the calculated investment objective can be categorized as an income investment objective. If the account beta is greater than 0.66 (e.g., second beta threshold 304) and the account yield is less than stock index yield 308, the calculated investment objective can be categorized as a growth investment objective. If the account beta is between 0 and 0.66 (e.g., second beta threshold 304) and the account yield is less than bond index yield 306, the calculated investment objective may be categorized as a total return investment objective. If the account beta is between 0.33 (e.g., first beta threshold 302) and 0.66 (e.g, second beta threshold) and account yield is greater than bond index yield 306, the calculated investment objective may be categorized as a total return investment objective. If the account beta is greater than 0.66 (e.g., second beta threshold 304) and the account yield is greater than the stock index yield, the calculated investment objective may be total return.

Bond index yield 306 may be a yield of a broad bond index which may broadly measure the overall return of bond markets. Stock index yield 308 may be a yield of a stock market index structured to represent the overall market. Bond index used for bond index yield 306 and stock index used for stock index yield may be selected based on the type of holdings being evaluated. The indexes may be selected to be comparable benchmarks for the holdings. For example, if the holdings include international holdings, a stock market index which includes international securities may be used. As another example, if the bond holdings are comprised of corporate bonds, a bond index for corporate type bonds may be used. Bond index yield 306 may be greater than stock index yield 308.

In some aspects, buffer zones around beta thresholds 302, 304, bond index yield 306, and stock index yield 308 may be used to provide flexibility in the securities allocation and to account for short-term volatility in the holdings without affecting an investment objective categorization of the holdings. A first beta buffer zone 310 may be provided as a range centered around first beta threshold 302. For example, first beta buffer zone 310 may be a first buffer value plus and minus first beta threshold 302. In the example shown in FIG. 3, the first buffer value may be ±0.05 of first beta threshold 302, in other words, have a beta range from 0.28 to 0.38. A second beta buffer zone 312 may be a second buffer value plus and minus second beta threshold 304. The second buffer value may be smaller than the first buffer value. For example, the second buffer value may be ±0.075 and range from 0.585 and 0.735 as shown in FIG. 3. In some aspects, buffer zones 310, 312 may be asymmetrical around beta thresholds 302, 304 such that the range of the buffer zone on either side of a beta threshold may be different. The account beta may be periodically calculated and used to periodically evaluate the calculated investment objective categorization of the account. A notification may be sent in response to changes in the investment objective categorization of the account after a periodic evaluation. Beta buffer zones 310, 312 may be used to avoid unnecessary updates or notifications to the investment objective of the account for small changes in the beta. The size of the beta buffer zones may be adjusted depending on the sensitivity of the strategy to beta changes.

A yield buffer zone 314 may be used to extend the account yield range for an income investment objective from bond index yield 306. Yield buffer zone 314 may be calculated based on a combination of yields of different bond and/or stock indexes. For example, the range of yield buffer zone may be equal to 0.5 x (the yield of a domestic broad stock market index+the yield of a domestic broad bond market index). Yield buffer zone 314 may extend from bond index yield 306 to a range below bond index yield 306. Yield buffer zone 314 may be used to enable de-risking of income strategies without affecting the income investment objective categorization of the holdings.

A yield buffer zone 316 may be used to extend the account yield range for a growth investment objective around stock index yield 308. The lower end of yield buffer zone 316 may be 0.5 of stock index yield 308 and the upper end of yield buffer zone 316 may be a yield of another stock market index such as a dividend yield of top domestic companies. Yield buffer zone 316 may be used to allow tactical and dynamic strategies to achieve return objectives in a low growth environment.

FIG. 4 illustrates an example method of determining whether a portfolio of securities holdings aligns with a client's designated investment objective. At step 402, the method may determine which accounts or holdings are part of the portfolio to be evaluated. For example, a client may have a financial advisor discretionary account, a client discretionary account, and a firm discretionary account. One or more of the accounts may be considered to be part of the portfolio being analyzed. The method described herein may be applied individually to each account to evaluate whether the account is meeting the investment objective designated for the account or to evaluate whether holdings across several accounts are meeting the designated investment objective. For a portfolio including multiple accounts, the holdings of each account may be combined and the combined holdings of the portfolio may be evaluated as a single account. As discussed with respect to FIG. 3, each investment objective is characterized by at least one growth factor range (e.g., beta) and at least one yield range.

In step 402, a growth factor such as beta may be calculated for each holding in the accounts to be evaluated. Beta of a holding i may be calculated using the following equation:

$${Beta}_{i} = \frac{covariance of security returns and equity index returns}{variance of equity index}$$

The equity index returns used may be returns (e.g., price appreciation and dividend payments) based on the broad stock market index used for stock index yield 308.

At step 404, an account beta may be calculated based on the betas of individual holdings and the weight of each holding in the account. The weight may be, for example, the proportion of assets in the holding compared to all of the assets in the account and may be in the form of a percentage. An account or portfolio beta may be calculated based on the following equation:

$${\sum }_{i = 1}^{n} {Beta}_{i} \times {Weight}_{i}$$

where:
Weightᵢ=weight of holding i in the account or portfolio,
Betaᵢ=the beta of holding i, and
n=the number of holdings.

At step 406, a yield of the individual holdings in the account may be determined or calculated from the specifics of the holding and/or publicly available information. For example, the yield of a stock may be the dividend paid per share divided by the price per share. The yield of a bond may be the yield to maturity (YTM) or the amount of interest paid (i.e., coupon interest) on the bond divided by the market price of the bond.

At step 408, an account yield may be calculated based on the yield of the individual holdings and the weight of the individual holdings. The weight may be, for example, the proportion of assets in the holding compared to all of the assets in the account and may be in the form of a percentage. An account or portfolio yield may be the holdings weighted average yield of the strategy over the trailing three months and may be calculated with the following equation:

$${\sum }_{t - 3 m}^{t} {\sum }_{i = 1}^{n} {Yield}_{i} ( t ) \times {Weight}_{i} ( t )$$

where:
Yieldᵢ(t)=the yield of holding i at time t where yield is the yield to maturity (YTM) for bonds and dividend yield for stocks,
Weightᵢ(t)=weight of holding i at time t,
t−3m=time minus 3 months, and
n=number of holdings.

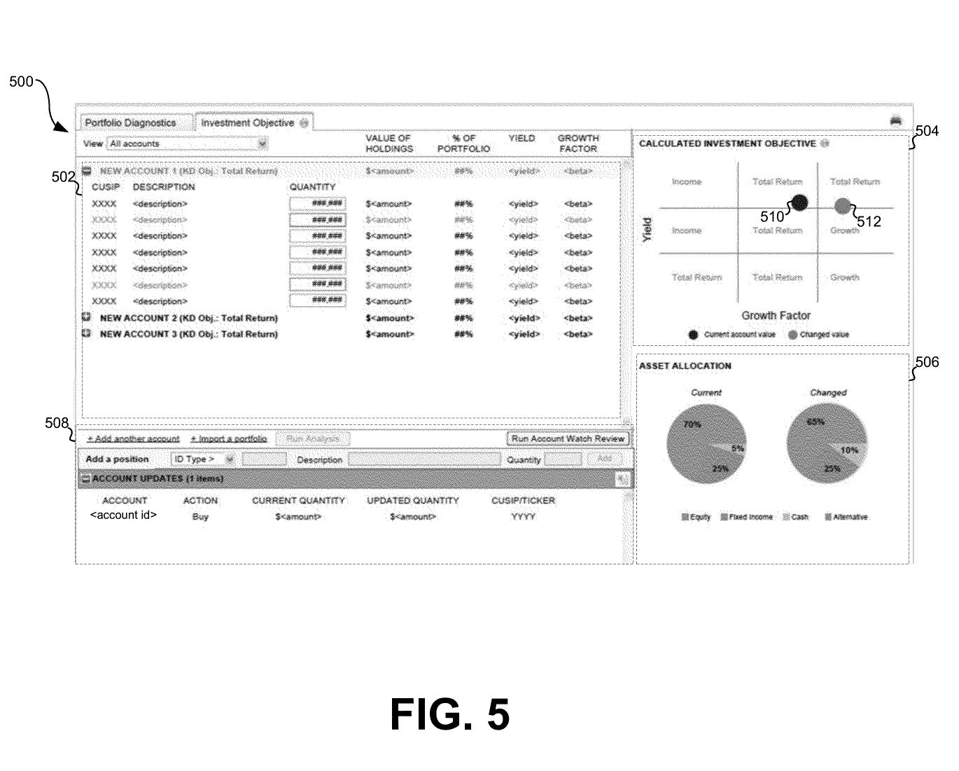

At step 410, a calculated investment objective for the account may be calculated or determined based on the account beta and the account yield. For example, based on the investment objective categories parameters described with respect to FIG. 3, a calculated investment objective for the account may be determined depending on the ranges in which the account beta and the account yield fall. The system may determine the possible investment objective categories for a particular account beta and then determine the calculated investment objective category from the account yield. The account beta and the account yield may also be used as coordinates in the form of (account beta, account yield) to graphically display the investment objective category as will be described in more detail with respect to FIG. 5. If the calculated investment objective is the same as the client-designated investment objective, the account or portfolio holdings may be considered to be in alignment. If the calculated investment objective is not the same as the client-designated investment objective, the account or portfolio holdings may not be aligned. For example, if the calculated investment objective is growth and the client-designated investment objective is growth, the portfolio investment objective is in alignment or matches the client-designated investment objective.

Steps 402-410 may be aperiodically repeated (e.g., based on user requests) or periodically repeated according to a schedule (e.g., monthly, weekly, daily) to re-evaluate the investment objective category of the portfolio in view of changing yields and betas and allocations. In re-evaluating the investment objective category of the portfolio, buffer zones 310, 312, 314, 316 may be used as described with respect to FIG. 3 to provide flexibility in changing yields, betas, or underlying holdings without triggering a change in the investment objective category of the portfolio. For example, if the recalculated yield or beta is within a buffer zone, the current calculated investment objective for the portfolio may be maintained despite the beta and/or yield no longer meeting the parameters defined for the calculated investment objective. In another example, if the recalculated yield or beta is within a buffer zone after a predetermined amount of time, the investment objective may be updated to a new investment objective based on the ranges in which the current betas and yields fall (i.e., without considering whether the beta or yield are within buffer zones).

At step 412, a user or system can determine whether the investment objective category of the current holdings is aligned with the client's designated investment objective for the portfolio or accounts. The system can determine this based on the calculated account beta and calculated account yield. From a graphical display, a user can easily determine which investment objective category the current holdings are and which parameters should be adjusted to change the investment objective category of the holdings which may be accomplished by adding holdings with specific beta or yield characteristics. For example, to increase the beta of the portfolio, holdings in a security with a higher beta may be added or the weight and/or allocation of an existing higher beta security may be increased and the system may repeat steps 402-410 to recalculate the account yield and account beta based on these updated holdings.

FIG. 5 illustrates an example user interface 500 for an investment objective evaluation tool and information related to the investment objective. As described herein, the investment objective may be evaluated for holdings in a particular account or holdings in a portfolio which may include one or more accounts. For example, the user interface 500 may list in a first area 502 accounts of the client and information associated with the accounts including the designated investment objective of the account, individual holdings in the account, and the accounts being considered together in a portfolio. The individual holdings may be identified using the holding's unique identification number or ticker symbol. The value, percentage or weight in the portfolio, yield, and growth factor (e.g., beta) of each holding may be displayed. A version 504 of the chart shown in FIG. 3 may be provided in the user interface 500. The chart may show the calculated investment objective for the account or the overall portfolio with respect to thresholds 302, 304 and index yields 306, 308. The yield and growth factor may be used to place a first point 510 on the chart where first point 510 provides an indication of the calculated investment objective for the account or portfolio depending on the area in which first point 510 is placed. The current asset allocation of the account or portfolio may be shown as percentages in a chart (e.g., bar chart, pie chart). As discussed with respect to FIG. 4, the method and tool described herein may enable a user to adjust the holdings in an account or portfolio to change the calculated investment objective to better align with the designated investment objective. A position in a new holding or increasing or decreasing a position in a holding may be done to change the calculated investment objective. For example, in area 508 of the user interface 500, a buy position in a holding is added resulting in a change in the calculated investment objective which may be shown with a second point 512 on chart 504 and in the “changed” chart shown in 506. Using this interface 500, a user can change allocations in an account or portfolio and be provided with an updated calculated investment objective based on the new holdings. In some aspects, user interface 500 may be used for scenario analysis where hypothetical changes to the account or portfolio holdings may be made to determine the potential effect of the changes to the calculated investment objective of the account or portfolio. For example, the buy entry may be an unexecuted order which is used to ascertain how such an executed order would affect the calculated investment objective. The account beta and account yield may be recalculated as described herein as if the buy order had been executed to produce a changed or updated calculated investment objective.

Other user interfaces may be used to provide different sets of information. For example, a supervisory interface may be used to provide information regarding designated investment objectives of accounts and whether the calculated investment objectives are in alignment with the designated investment objectives of the accounts. Another interface may provide alerts for accounts which have calculated investment objectives that do not match the designated investment objectives.

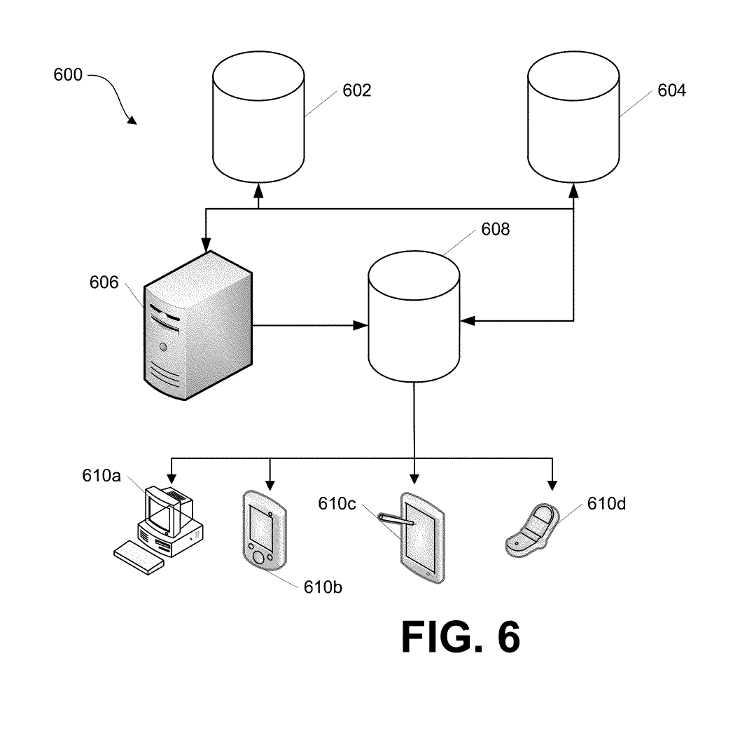

FIG. 6 illustrates an example system 600 which may execute steps or aspects described herein. One or more of databases 602, 604 may store yield information and/or beta information used in calculating yield and/or beta such as market price, interest payments, or dividend payments or yields and/or betas for various securities. The data may be yield and/or beta information over a period of time (e.g., days, weeks, months, years). One or more of the databases 602, 604 may store portfolio or account information such as holdings in each account or portfolio.

Servers or computing devices 606 may be used to calculate account beta or account yield as described with respect to FIG. 4. For example, server 606 may be an account beta server which receives beta information and holdings information from databases 602, 604 to calculate account beta as described herein and an account yield server which receives yield information and holdings information from databases 602, 604 to calculate account yield as described herein. Server 606 may determine a calculated investment objective based on the calculated account beta and account yield and transmit the calculated investment objective and beta and yield information for storage in an investment objective database 608. Database 608 may receive account beta and account yield information and calculated investment objective information and store the investment objective information for the account or portfolio and beta and yield information. Various types of computing devices 610 (e.g., computer, personal digital assistant (PDA), tablet computer, mobile phone) may interact with database 608 to retrieve portfolio or account information such as investment objective information, beta information, yield information, and holdings information. The information may be presented in the form of a user interface and tool as described with respect to FIG. 5.

The methods, apparatuses, systems, and computer-readable mediums described herein provide a user with the ability to quantitatively determine whether the returns and risk or volatility of a portfolio of holdings is alignment with a client's investment objectives which may be associated with a range of returns and risks on the holdings. The aspects described herein further enable a user to adjust holdings to better align the holdings with returns and risks associated a particular investment objective. Because the aspects described herein provide a quantitative manner of measuring performance with respect to investment objectives, the aspects described herein enable automatic notification of changes in investment objectives of the current holdings and easy supervision of, for example, financial advisors responsible for the accounts or portfolios. The tool can enable a client to manage broad investment objective strategies as well.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. A method, comprising:
determining, by a computing system comprising at least one processor, a calculated growth factor of a portfolio of securities assets;
determining, by the computing system, a calculated yield of the portfolio of securities assets;
comparing, by the computing system, the calculated growth factor and growth factor ranges associated with different investment objectives, the growth factor ranges being defined based on at least two thresholds;
comparing, by the computing system, the calculated yield and yield ranges associated with the different investment objectives, the yield ranges being defined based on at least one of a bond index yield and a stock index yield;
determining, by the computing system, a calculated investment objective of the portfolio based on the comparing of the calculated growth factor and the growth factor ranges and the comparing of the calculated yield and the yield ranges; and
determining, by the computing system, whether the calculated investment objective of the portfolio matches a client-designated investment objective of the portfolio.

2. The method of claim 1, wherein the growth factor is a beta of the portfolio of assets calculated according to the following equation:
$${\sum }_{i = 1}^{n} {Beta}_{i} \times {Weight}_{i}$$
where:
Weightᵢ=weight of asset i in the portfolio,
Betaᵢ is the beta of asset i, and
n=number of assets in the portfolio, and
wherein the yield is calculated according to the following equation:
$${\sum }_{t - 3 m}^{t} {\sum }_{i = 1}^{n} {Yield}_{i} ( t ) \times {Weight}_{i} ( t )$$
where:
Yieldᵢ(t)=the yield of asset i at time t where yield is the yield to maturity (YTM) for bonds and dividend yield for stocks,
Weightᵢ(t)=weight of asset i in the portfolio at time t,
t−3m=time minus 3 months, and
n=number of assets in the portfolio.

3. The method of claim 1, wherein a first growth factor threshold is less than a second growth factor threshold, and
wherein the different investment objectives comprise:
an income investment objective having a growth factor less than the first growth factor threshold and a yield greater than the bond index yield;
a growth investment objective having a growth factor greater than the second growth factor threshold and a yield less than the stock index yield; and
a total return investment objective having a growth factor less than the second growth factor threshold and a yield less than the bond index yield, having a growth factor between the first growth factor threshold and the second growth factor threshold and a yield greater than the bond index yield, and having a growth factor greater than the second growth factor threshold and a yield greater than the stock index yield.

4. The method of claim 3, wherein the first growth factor threshold is 0.33 and the second growth factor threshold is 0.66.

5. The method of claim 1, further comprising:
receiving, by the computing system, a request to change the assets in the portfolio;
in response to receiving the request, determining, by the computing system, a recalculated growth factor;
in response to receiving the request, determining, by the computing system, a recalculated yield; and
updating, by the computing system, the calculated investment objective of the portfolio based on the recalculated growth factor and the recalculated yield.

6. The method of claim 1, further comprising:
periodically updating, by the computing system, the calculated investment objective by recalculating the growth factor and the yield; and
providing, by the computing system, an account alert in response to the updated investment objective deviating from the client-designated investment objective.

7. The method of claim 6, wherein providing the account alert comprises:
determining whether a recalculated growth factor is outside of a growth factor buffer zone;
in response to determining that the recalculated growth factor is outside of the growth factor buffer zone, sending the account alert;
determining whether a recalculated yield is outside of a yield buffer zone;
in response to determining that the recalculated yield is outside of the yield buffer zone, sending the account alert; and
in response to determining that the recalculated growth factor is within the growth factor buffer zone and the recalculated yield is within the yield buffer zone, maintaining the calculated investment objective.

8. An apparatus, comprising:
at least one processor; and
a memory storing computer-readable instructions that, when executed by the at least one processor, cause the apparatus to:
determine a calculated growth factor of a portfolio of securities assets,
determine a calculated yield of the portfolio of securities assets,
compare the calculated growth factor and growth factor ranges associated with different investment objectives, the growth factor ranges being defined based on at least two thresholds,
compare the calculated yield and yield ranges associated with the different investment objectives, the yield ranges being defined based on at least one of a bond index yield and a stock index yield,
determine a calculated investment objective of the portfolio based on the comparing of the calculated growth factor and the growth factor ranges and the comparing of the calculated yield and the yield ranges, and
determine whether the calculated investment objective of the portfolio matches a client-designated investment objective of the portfolio.

9. The apparatus of claim 8, wherein the growth factor is a beta of the portfolio of assets calculated according to the following equation:
$${\sum }_{i = 1}^{n} {Beta}_{i} \times {Weight}_{i}$$
where:
Weightᵢ=weight of asset i in the portfolio,
Betaᵢ is the beta of asset i, and
n=number of assets in the portfolio, and
wherein the yield is calculated according to the following equation:
$${\sum }_{t - 3 m}^{t} {\sum }_{i = 1}^{n} {Yield}_{i} ( t ) \times {Weight}_{i} ( t )$$
where:
Yieldᵢ(t)=the yield of asset i at time t where yield is the yield to maturity (YTM) for bonds and dividend yield for stocks,
Weightᵢ(t)=weight of asset i in the portfolio at time t,
t−3m=time minus 3 months, and
n=number of assets in the portfolio.

10. The apparatus of claim 8, wherein a first growth factor threshold is less than a second growth factor threshold, and
wherein the different investment objectives comprise:
an income investment objective having a growth factor less than the first growth factor threshold and a yield greater than the bond index yield,
a growth investment objective having a growth factor greater than the second growth factor threshold and a yield less than the stock index yield, and
a total return investment objective having a growth factor less than the second growth factor threshold and a yield less than the bond index yield, a growth factor between the first growth factor threshold and the second growth factor threshold and a yield greater than the bond index yield, and a growth factor greater than the second growth factor threshold and a yield greater than the stock index yield.

11. The apparatus of claim 10, wherein the first growth factor threshold is 0.33 and the second growth factor threshold is 0.66.

12. The apparatus of claim 8, wherein the memory further stores computer-readable instructions that, when executed by the at least one processor, cause the apparatus to:
receive a request to change the assets in the portfolio;
in response to receiving the request, determine a recalculated growth factor;
in response to receiving the request, determine a recalculated yield; and
update the calculated investment objective of the portfolio based on the recalculated growth factor and the recalculated yield.

13. The apparatus of claim 8, wherein the memory further stores computer-readable instructions that, when executed by the at least one processor, cause the apparatus to:
periodically update the calculated investment objective by recalculating the growth factor and the yield; and
provide an account alert in response to the updated investment objective deviating from the client-designated investment objective.

14. The apparatus of claim 13, wherein providing the account alert comprises:
determine whether a recalculated growth factor is outside of a growth factor buffer zone;
in response to determining that the recalculated growth factor is outside of the growth factor buffer zone, send the account alert;
determine whether a recalculated yield is outside of a yield buffer zone;
in response to determining that the recalculated yield is outside of the yield buffer zone, send the account alert; and
in response to determining that the recalculated growth factor is within the growth factor buffer zone and the recalculated yield is within the yield buffer zone, maintain the calculated investment objective.

15. One or more non-transitory computer-readable media having computer-executable instructions stored thereon that, when executed, cause at least one computing device to:
determine a calculated growth factor of a portfolio of securities assets;
determine a calculated yield of the portfolio of securities assets;
compare the calculated growth factor and growth factor ranges associated with different investment objectives, the growth factor ranges being defined based on at least two thresholds;
compare the calculated yield and yield ranges associated with the different investment objectives, the yield ranges being defined based on at least one of a bond index yield and a stock index yield;
determine a calculated investment objective of the portfolio based on the comparing of the calculated growth factor and the growth factor ranges and the comparing of the calculated yield and the yield ranges; and
determine whether the calculated investment objective of the portfolio matches a client-designated investment objective of the portfolio.

16. The one or more non-transitory computer-readable media of claim 15, wherein the growth factor is a beta of the portfolio of assets calculated according to the following equation:
$${\sum }_{i = 1}^{n} {Beta}_{i} \times {Weight}_{i}$$
where:
Weightᵢ=weight of asset i in the portfolio,
Betaᵢ is the beta of asset i, and
n=number of assets in the portfolio, and
wherein the yield is calculated according to the following equation:
$${\sum }_{t - 3 m}^{t} {\sum }_{i = 1}^{n} {Yield}_{i} ( t ) \times {Weight}_{i} ( t )$$
where:
Yieldᵢ(t)=the yield of asset i at time t where yield is the yield to maturity (YTM) for bonds and dividend yield for stocks,
Weightᵢ(t)=weight of asset i in the portfolio at time t,
t−3m=time minus 3 months, and
n=number of assets in the portfolio.

17. The one or more non-transitory computer-readable media of claim 15, wherein a first growth factor threshold is less than a second growth factor threshold, and
wherein the different investment objectives comprise:
an income investment objective having a growth factor less than the first growth factor threshold and a yield greater than the bond index yield,
a growth investment objective having a growth factor greater than the second growth factor threshold and a yield less than the stock index yield, and
a total return investment objective having a growth factor less than the second growth factor threshold and a yield less than the bond index yield, a growth factor between the first growth factor threshold and the second growth factor threshold and a yield greater than the bond index yield, and a growth factor greater than the second growth factor threshold and a yield greater than the stock index yield.

18. The one or more non-transitory computer-readable media of claim 17, wherein the first growth factor threshold is 0.33 and the second growth factor threshold is 0.66.

19. The one or more non-transitory computer-readable media of claim 15, further including instructions that, when executed, cause the at least one computing device to:
receive a request to change the assets in the portfolio;
in response to receiving the request, determine a recalculated growth factor;
in response to receiving the request, determine a recalculated yield; and
update the calculated investment objective of the portfolio based on the recalculated growth factor and the recalculated yield.

20. The one or more non-transitory computer-readable media of claim 15, further including instructions that, when executed, cause the at least one computing device to:
periodically update the calculated investment objective by recalculating the growth factor and the yield; and
provide an account alert in response to the updated investment objective deviating from the client-designated investment objective, wherein providing the account alert comprises:
determine whether a recalculated growth factor is outside of a growth factor buffer zone;
in response to determining that the recalculated growth factor is outside of the growth factor buffer zone, send the account alert;
determine whether a recalculated yield is outside of a yield buffer zone;
in response to determining that the recalculated yield is outside of the yield buffer zone, send the account alert; and
in response to determining that the recalculated growth factor is within the growth factor buffer zone and the recalculated yield is within the yield buffer zone, maintain the calculated investment objective.
